(19) United States
(12) Patent Application Publication
(10) Pub. No.: US 2003/0205681 A1
(43) Pub. Date: Nov. 6, 2003

(54) Evanescent field illumination devices and methods

(75) Inventor: Douglas N. Modlin, Palo Alto, CA (US)

Correspondence Address: KOLISCH, HARTWELL, DICKINSON, McCORMACK & HEUSER, Suite 200, 520 S.W. Yamhill Street, Portland, OR, 97204, US

(73) Assignee: LJL BioSystems, Inc.

(21) Appl. No.: 09/759,711

(22) Filed: Jan. 12, 2001

Related U.S. Application Data
(63) Continuation of application No. PCT/US99/16057, filed on Jul. 15, 1999.
(60) Provisional application No. 60/093,838, filed on Jul. 22, 1998.
(60) Provisional application No. 60/094,275, filed on Jul. 27, 1998.
(60) Provisional application No. 60/094,276, filed on Jul. 27, 1998.
(60) Provisional application No. 60/094,306, filed on Jul. 27, 1998.
(60) Provisional application No. 60/100,817, filed on Sep. 18, 1998.
(60) Provisional application No. 60/100,951, filed on Sep. 18, 1998.
(60) Provisional application No. 60/104,964, filed on Oct. 20, 1998.
(60) Provisional application No. 60/114,209, filed on Dec. 29, 1998.
(60) Provisional application No. 60/116,113, filed on Jan. 15, 1999.
(60) Provisional application No. 60/117,278, filed on Jan. 26, 1999.
(60) Provisional application No. 60/119,884, filed on Feb. 12, 1999.
(60) Provisional application No. 60/121,229, filed on Feb. 23, 1999.
(60) Provisional application No. 60/124,686, filed on Mar. 16, 1999.
(60) Provisional application No. 60/125,346, filed on Mar. 19, 1999.
(60) Provisional application No. 60/126,661, filed on Mar. 29, 1999.
(60) Provisional application No. 60/130,149, filed on Apr. 20, 1999.
(60) Provisional application No. 60/132,262, filed on May 3, 1999.
(60) Provisional application No. 60/132,263, filed on May 3, 1999.
(60) Provisional application No. 60/135,284, filed on May 21, 1999.
(60) Provisional application No. 60/136,566, filed on May 28, 1999.
(60) Provisional application No. 60/138,311, filed on Jun. 9, 1999.
(60) Provisional application No. 60/138,438, filed on Jun. 10, 1999.
(60) Provisional application No. 60/138,737, filed on Jun. 11, 1999.
(60) Provisional application No. 60/138,893, filed on Jun. 11, 1999.
(60) Provisional application No. 60/142,721, filed on Jul. 7, 1999.
(60) Provisional application No. 60/143,185, filed on Jul. 9, 1999.

(51) Int. Cl. G01N 21/64

(52) U.S. Cl. 250/458.1; 250/459.1; 422/82.08; 422/102

(57) ABSTRACT

Devices and methods are disclosed comprising providing a sample holder having a plurality of sample wells. Inner and outer surfaces of at least one well are configured for total internal reflection of incident light.

### CROSS-REFERENCE TO RELATED APPLICATIONS

This application is a continuation of PCT Patent Application Serial No. PCT/US99/16057, filed Jul. 15, 1999, which is incorporated herein by reference.

This application claims priority from the following applications, each of which is incorporated herein by reference: U.S. patent application Ser. No. 09/160,533, filed Sep. 24, 1998; PCT Patent Application Serial No. PCT/US98/14575, filed Jul. 15, 1998; and U.S. Provisional Patent Application Serial No. 60/093,838, filed Jul. 22, 1998.

This application incorporates by reference the following U.S. patent applications: Ser. No. 09/156,318, filed Sep. 18, 1998; and Ser. No. 09/349,733, filed Jul. 8, 1999.

This application incorporates by reference the following PCT patent applications: Serial No. PCT/US98/23095, filed Oct. 30, 1998; Serial No. PCT/US99/01656, filed Jan. 25, 1999; Serial No. PCT/US99/03678, filed Feb. 19, 1999; and Serial No. PCT/US99/08410, filed Apr. 16, 1999.

This application incorporates by reference the following U.S. provisional patent applications: Serial No. 60/094,275, filed Jul. 27, 1998; Serial No. 60/094,276, filed Jul. 27, 1998; Serial No. 60/094,306, filed Jul. 27, 1998; Serial No. 60/100,817, filed Sep. 18, 1998; Serial No. 60/100,951, filed Sep. 18, 1998; Serial No. 60/104,964, filed Oct. 20, 1998; Serial No. 60/114,209, filed Dec. 29, 1998; Serial No. 60/116,113, filed Jan. 15, 1999; Serial No. 60/117,278, filed Jan. 26, 1999; Serial No. 60/119,884, filed Feb. 12, 1999; Serial No. 60/121,229, filed Feb. 23, 1999; Serial No. 60/124,686, filed Mar. 16, 1999; Serial No. 60/125,346, filed Mar. 19, 1999; Serial No. 60/126,661, filed Mar. 29, 1999; Serial No. 60/130,149, filed Apr. 20, 1999; Serial No. 60/132,262, filed May 3, 1999; Serial No. 60/132,263, filed May 3, 1999; Serial No. 60/135,284, filed May 21, 1999; Serial No. 60/136,566, filed May 28, 1999; Serial No. 60/138,311, filed Jun. 9, 1999; Serial No. 60/138,438, filed Jun. 10, 1999; Serial No. 60/138,737, filed Jun. 11, 1999; Serial No. 60/138,893, filed Jun. 11, 1999; Serial No. 60/142,721, filed Jul. 7, 1999; and Serial No. 60/143,185, filed Jul. 9, 1999.

This application also incorporates by reference the following publications: Max Born and Emil Wolf, Principles of Optics (6^{th} ed. 1980); Richard P. Haugland, Handbook of Fluorescent Probes and Research Chemicals (6^{th} ed. 1996); and Joseph R. Lakowicz, Principles of Fluorescence Spectroscopy (1983).

### FIELD OF THE INVENTION

The invention relates to luminescence. More particularly, the invention relates to devices and methods for detecting luminescence from molecules at or near surfaces in a plurality of sample wells using total internal reflection.

### BACKGROUND OF THE INVENTION

The distribution and dynamics of molecules at or near surfaces influence numerous phenomena in biology, chemistry, and physics. In biology alone, such phenomena include the binding of hormones, neurotransmitters, and antigens to cell membrane receptors in cell triggering, the deposition of plasma proteins at foreign surfaces in thrombosis, and the adhesion of cells to substrates.

The distribution and dynamics of molecules at or near surfaces generally will differ from the distribution and dynamics of molecules in bulk solution. For example, reaction rates may be enhanced at surfaces if reaction partners are localized through nonspecific adsorption and surface diffusion. Similarly, bound molecules may be more completely immobilized by binding to a surface than to another soluble molecule. Such differences can be exploited by industry and medicine, as well as by biological systems. Such differences may be especially important in high-throughput screening (HTS) of candidate drug compounds, where tens or hundreds of thousands of samples may be analyzed.

Surface binding and surface reactions may be detected using various techniques, including luminescence. Luminescence is the emission of light from excited electronic states of atoms or molecules. Luminescence generally refers to all kinds of light emission, except incandescence, and may include photoluminescence, chemiluminescence, and electrochemiluminescence, among others. In photoluminescence, including fluorescence and phosphorescence, the excited electronic state is created by the absorption of electromagnetic radiation. In chemiluminescence, which includes bioluminescence, the excited electronic state is created by a transfer of chemical energy. In electrochemiluminescence, the excited electronic state is created by an electrochemical process.

Luminescence assays are assays that use luminescence emissions from luminescent analytes (“luminophores”) to study the properties and environment of the analyte, as well as binding reactions and enzymatic activities involving the analyte, among others. In this sense, the analyte may act as a reporter to provide information about another material or target substance that may be the focus of the assay. Luminescence assays involve various aspects of the luminescence, including its intensity, polarization, and lifetime, among others. Luminescence assays also may involve time-independent (steady-state) and/or time-dependent (time-resolved) properties of the luminescence. Generally, steady-state assays are less complicated than time-resolved assays but yield less information.

Detecting surface binding using luminescence methods may require detecting changes in the relative numbers of bound and/or unbound luminophores. Unfortunately, if binding occurs adjacent bulk solution, there typically will be many fewer bound luminophores than unbound luminophores. Under such conditions, changes in the number of bound luminophores will be difficult to detect because the observed luminescence will be (vastly) dominated by luminescence from unbound luminophores. Similarly, changes in the number of unbound luminophores will be difficult to detect because the number of unbound luminophores will be relatively unaffected by binding.

To detect bound luminophores using conventional techniques, luminescence from unbound luminophores must be rejected, and/or the number of bound luminophores must about equal or exceed the number of unbound luminophores.

Luminescence from unbound luminophores may be rejected using confocal optics, which physically rejects light from above and below a predetermined depth of field. Suitable (submicrometer) depths of field may be achieved only by illuminating small (1-50 micrometer-diameter) areas of a sample. Unfortunately, if only small areas are illuminated, signal averaging typically must be performed to collect data with acceptable signal-to-noise ratios, usually by scanning a surface using autofocus. This approach is slow and creates very large amounts of data.

Luminescence from unbound luminophores also may be rejected by removing bulk solution by aspiration. Unfortunately, aspiration is unsuitable for many assays because the thin layer of solution remaining after aspiration is subject to evaporation, which may kill cells and concentrate luminophores, perturbing binding. In addition, the thin layer may be of unknown or poorly characterized thickness, so that it may be difficult to determine the number of unbound luminophores remaining in the thin layer.

Aspiration also suffers from technical limitations. If sample volume is low, as in high-density microplates, the high surface tension of typical aqueous samples will make it difficult to rinse or add solution. Moreover, aspiration equipment may need to be washed or changed between assays to prevent cross-contamination.

If luminophores are essentially irreversibly bound to the surface, luminescence from unbound luminophores also may be rejected by replacing bulk solution with fresh solution lacking unbound luminophores. Unfortunately, such an approach requires even more steps than aspiration alone, for example, aspiration-addition, or aspiration-rinse-aspiration-addition.

### SUMMARY OF THE INVENTION

The invention provides devices and methods for detecting luminescence from molecules at or near a surface in a plurality of samples. The invention excites such luminescence using an evanescent electromagnetic field created by total internal reflection of light off a suitable wall of a multi-well sample holder.

### BRIEF DESCRIPTION OF THE DRAWINGS

FIG. 1 is a flow chart showing a method of detecting luminescence in accordance with the invention.

FIG. 2 is a schematic view of refraction and reflection at an optical interface.

FIG. 3 is a top view of a sample holder constructed in accordance with the invention.

FIG. 4 is a partially schematic side view of a system for detecting luminescence in accordance with the invention, showing total internal reflection and detection of luminescence from molecules excited by an evanescent field in a portion of the sample holder of FIG. 3.

FIG. 5 is a partially schematic side view of portions of an alternative system for detecting luminescence in accordance with the invention, showing an alternative sample holder.

FIG. 6 is a schematic view of luminescently labeled molecules, showing how molecular reorientation affects luminescence polarization.

FIG. 7 is a schematic view of a frequency-domain time-resolved measurement, showing the definitions of phase angle (phase) φ and demodulation factor (modulation) M.

FIG. 8 is a schematic view of an apparatus for detecting light in accordance with the invention.

FIG. 9 is a partially schematic perspective view of the apparatus of FIG. 8.

FIG. 10 is a partially schematic side elevation view of the optics assembly shown in FIG. 8, showing off-axis illumination suitable for total internal reflection.

FIG. 11 is a schematic view of photoluminescence optical components from the apparatus of FIG. 8.

FIG. 12 is a schematic view of chemiluminescence optical components from the apparatus of FIG. 8.

FIG. 13 is a partially exploded perspective view of a housing for the apparatus of FIG. 8.

FIG. 14 is a schematic view of an alternative apparatus for detecting light in accordance with the invention.

### DETAILED DESCRIPTION OF THE INVENTION

The invention provides devices and methods for detecting luminescence from luminescent molecules at or near a surface in a plurality of samples. The invention uses an evanescent electromagnetic field created by total internal reflection of light off a suitable wall of the sample holder to excite such luminescence.

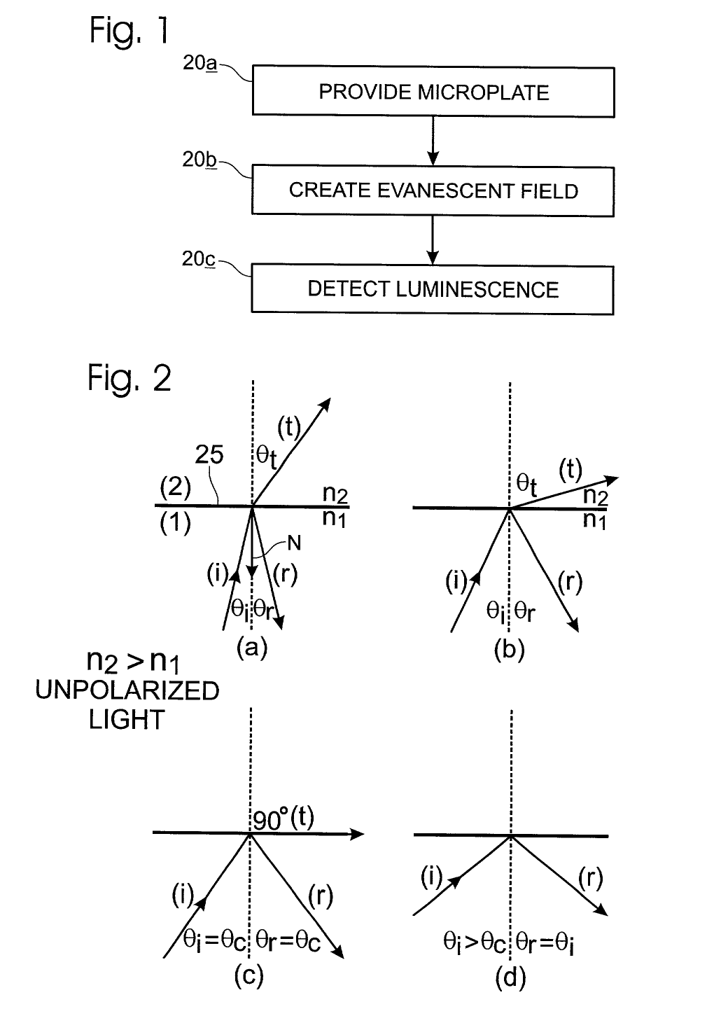

FIG. 1 shows a method provided by the invention. First, a microplate is provided having a plurality of sample wells (block 20a). At least one of the sample wells has a wall capable of transmitting light, where the wall has an outer surface and an inner surface configured to contact a sample held within the sample well. Second, excitation light is directed through the outer surface so that it impinges on the inner surface at an angle sufficient for total internal reflection, thereby creating an evanescent field in the sample well (block 20b). Third, luminescence is detected that is emitted by a sample within the sample well in response to excitation by the evanescent field (block 20c).

The sample holders provided by the invention comprise a multi-well sample holder having a frame and a plurality of sample wells disposed in the frame, where at least one of the sample wells has a wall capable of transmitting light. A portion of this wall may have opposing nonparallel inner and outer surfaces.

The systems provided by the invention comprise a sample holder and an optical device. The sample holder has a frame and a plurality of sample wells disposed in the frame, where each sample well is configured to hold a fluid sample. The optical device has an examination site, a light source positioned to deliver light to the examination site, and a detector positioned to receive light transmitted from the examination site. The sample holder and optical device may be configured so that when the sample holder is positioned in the examination site, the optical device is capable of exciting and detecting luminescence substantially exclusively from a sensed volume adjacent an inner surface of at least one sample well in the sample holder. The sample holder and optical device also may be configured so that when the sample holder is positioned in the examination site, the optical device is capable of exciting and detecting luminescence from the sample substantially without penetration of the excitation light into a sample well.

These and other aspects of the invention are described in the remainder of this section, which is divided into four parts: (1) description of total internal reflection, (2) description of devices and methods, (3) description of luminescence assays, and (4) description of luminescence apparatus.

1. Description of Total Internal Reflection

FIG. 2 shows aspects of refraction and reflection, including total internal reflection (TIR). Panel A shows incident light (i) directed from a first medium (labeled 1) of higher refractive index n₁ onto an optical interface 25 with a second medium (labeled 2) of lower refractive index n₂. Incident light (i) makes an angle θᵢ with respect to a normal \vec{N} to the interface. At the interface, a portion of incident light (i) generally will be reflected (r), and a portion generally will be transmitted (t). The angle θᵣ between reflected light (r) and the normal is given by the law of reflection:

θᵣθᵢ (1)

The angle θₜ between transmitted light (t) and the normal is given by the law of refraction (i.e., Snell's Law):

n₁ sin θᵢ=n₂ sin θₜ (2)

The law of refraction shows that light directed from a medium of higher refractive index onto a medium of lower refractive index will bend away from the normal. The law of refraction also shows that θₜ will increase faster than θᵢ.

If energy is conserved at the interface, the energy in incident light (i) will be partitioned between reflected light (r) and transmitted light (t). The precise partitioning of energy between the reflected and transmitted light is given by the “Fresnel” equations; however, generally, as incidence angle θᵢ increases, the energy in transmitted light (t) decreases, and the energy in reflected light (r) increases.

Panels B-D show how increases in incidence angle θᵢ affect the refraction and reflection of light at the interface. Panel B shows that as incidence angle θᵢ increases (relative to Panel A), transmission angle θₜ also increases. Concomitantly, the fraction of energy associated with transmitted light (t) decreases, and the fraction of energy associated with reflected light (r) increases. Panel C shows that as incidence angle θᵢ increases further, transmission angle θₜ increases further until transmitted light (t) becomes tangent to the interface. The angle at which this occurs is known as the critical angle θ_{c} and can be determined by setting θₜ=90° in the Law of Refraction:

θ_{c}=sin⁻¹(n₂/n₁) (3)

Panel D shows that as incidence angle θᵢ increases beyond θ_{c}, all of incident light (i) is reflected back into medium 1, so that no light energy is carried across interface 25 into medium 2. This process is known as total internal reflection and is accompanied by the creation of a surface or evanescent electromagnetic field that penetrates only a short distance (<about 100 nm) into the second medium.

The evanescent field can be described mathematically. For example, if the optical interface is defined as an x-y plane and the incident plane as an x-z plane, the evanescent electric field created by an incident plane-wave beam of amplitude A that is polarized at an angle α from the incident plane will be given by the equation:

\vec{E}(\vec{r},t)=Re{A\vec{E}₀(θ, α)exp[i(k(θ)x−ωt)]}·exp{−z/[2d(θ)]}, (4)

where

E₀ₓ(θ, α)=aₓ(θ)cos α exp{−i└δₚ(θ)+π/2┘} (5a)

E_{0y}(θ, α)=a_{y}(θ)sin α exp[−iδₛ(θ)] (5b)

E_{0z}(θ, α)=a_{z}(θ)sin α exp└−iδₚ(θ)┘ (5c)

α_{x,z}(θ)=2 cos θX⁻¹(θ)[(sin² θ−n²)^{1/2}, sin θ] (5d)

α_{y}(θ)=2 cos θ/(1−n²)^{1/2} (5e)

X(θ)=(n⁴ cos² θ+sin² θ−n²)^{1/2} (5f)

δ_{s,p}(θ)=tan⁻¹{(sin² θ−n²)^{1/2}/([1n²]cos θ)} (5g)

d(θ)=λ₀/[4π(n₁² sin θ−n₂²)^{1/2}] (5h)

k(θ)=2πn₁ sin θ/λ₀ (5i)

n=n₂/n₁ (5j)

Here, s and p refer to S and P-polarized light, respectively, and θ is shorthand for θᵢ. The evanescent field corresponding to other forms of incident light, including partially polarized or unpolarized light and/or Gaussian beams, may be modeled as an appropriate superposition of Equations 4 and 5.

The intensity of light associated with the evanescent field may be derived using the Poynting vector.

The evanescent field is not transverse, meaning that \vec{E} has a component along propagation direction x. However, as shown in Equations 4 and 5, under some conditions \vec{E} may be nearly transverse because the component of \vec{E} along x is proportional to aₓ, which is much smaller than a_{y} and a_{z} for many incidence angles θᵢ and relative refractive indices n.

The critical angle θ_{c} is a function of the refractive indices of the two media, as shown in Equation 3. Generally, a smaller critical angle is desirable, because it means that incident light will be totally internally reflected over a greater range of angles. The critical angle may be decreased by increasing the refractive index of the first medium and by decreasing the refractive index of the second medium. However, as a practical matter, the refractive index of the second medium is fixed, because the second medium usually comprises a buffered aqueous solution having a refractive index of about 1.3.

The penetration depth d is a function of the wavelength λ₀ of incident light, the refractive indices n₁ and n₂ of the first and second media, and the incidence angle θᵢ, as shown in Equation 5h. The penetration depth may be increased by increasing λ₀ or by decreasing

$${( {n}_{1}^{2} sin θ - {n}_{2}^{2} )}^{1 / 2} .$$

The penetration depth also may be increased by coating the interface with a suitable material, such as a thin metal film.

2. Description of Devices and Methods

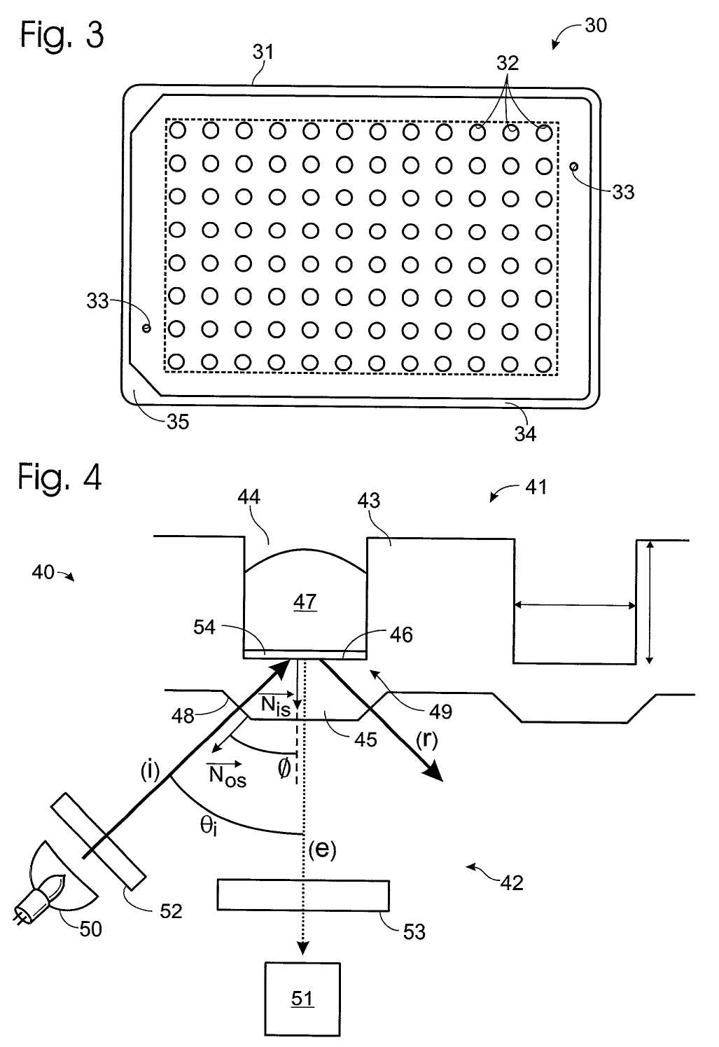

FIG. 3 shows a sample holder 30 constructed in accordance with the invention. Sample holder 30 includes a frame 31 and a plurality of sample wells 32 for holding a plurality of samples disposed in the frame. Sample holder 30 also may include one or more reference fiducials 33 disposed in the frame. Suitable reference fiducials and their uses, as well as suitable microplate compositions, are described in U.S. patent application Ser. No. 09/156,318 and PCT Patent Application Serial No. PCT/US99/08410, which are incorporated herein by reference. A preferred sample holder is a suitably configured microplate.

Frame 31 is the main structural component of sample holder 30. Frame 31 may have various shapes and various dimensions. In sample holder 30, frame 31 is substantially rectangular, with a major dimension X of about 127.8 mm and a minor dimension Y of about 85.5 mm. Frame 31 may be adapted for ease of use and manufacture. For example, frame 31 may include a base 34 to facilitate handling and/or stacking, and notches 35 to facilitate receiving a protective lid. Frame 31 may be constructed of a material, such as a thermoplastic, that is sturdy enough to permit repeated, rugged use, yet minimally photoluminescent to reduce background upon illumination.

Sample wells 32 are configured to hold fluid samples, so that they typically have an open end through which sample may be added or removed. The sample wells may have various shapes, including cylindrical, rectangular, and frusto-conical. The sample wells may be disposed in various configurations, including regular rectangular or hexagonal arrays. In FIG. 3, the sample holder includes 96 cylindrical sample wells disposed in an 8×12 rectangular array having 9 millimeter centers. In other configurations, the sample holder may include 384, 1536, or other numbers of wells arranged in the same or other configurations. Suitable wells may hold no more than about 1 microliter, no more than about 5 microliters, no more than about 55 microliters, or no more than other volumes, depending on the size and density of the sample wells.

FIG. 4 shows a partially schematic cross-sectional view of a system 40 for detecting luminescence in accordance with the invention. System 40 includes a sample holder 41 (such as sample holder 30 of FIG. 3) and an optical device 42.

Sample holder 41 includes a frame 43 and a plurality of sample wells 44 disposed in the frame. At least one sample well includes a wall 45 capable of transmitting light. Wall 45 has an inner surface 46 configured to contact a sample 47 within the sample well. Wall 45 also may have an opposing outer surface 48. In some embodiments, inner and outer surfaces may be substantially parallel. In other embodiments, inner and outer surfaces may be oriented so that at least portions of the surfaces are angled relative to one another.

Opposed surfaces in a sample well generally refers to an external surface on a portion of a wall and a directly opposing interior surface on the same wall. More specifically, an inner surface may be said to oppose an outer surface under the following conditions. The outer surface contains at least three points on an exterior side of a wall. These points are called external points. Each external point has a corresponding internal point at the point where a normal to the exterior point intersects the inner surface of the wall. The three internal points corresponding to the three external points define the opposing inner surface.

In FIG. 4, inner surface 46 is substantially planar. In contrast, outer surface 48 includes a substantially planar portion substantially parallel to inner surface 46 but also includes a substantially conical portion angled relative to inner surface 46. Specifically, a normal \vec{N}ᵢₛ to inner surface 46 and a normal \vec{N}ₒₛ to substantially conical portion of outer surface 48 form a nonzero angle φ. In other embodiments, outer surface 48 could be curved in multiple directions, for example, to correspond to a portion of a sphere, ellipsoid, or paraboloid. In yet other embodiments, outer surface 48 could include one or more indentations.

Angle φ may be chosen so that light incident on at least a portion of the outer surface along a normal to that portion of the outer surface will be totally internally reflected at the inner surface when the sample well is empty, or when the sample well includes a preferred fluid, such as water. If the inner surface is made of fused silica (aka “quartz”) (n₁≈1.5), then these angles will be at least about 42° when the sample well is empty (n₂≈1.0) and at least about 62° when the sample well includes water (n₂≈1.33). Further considerations relating to angle φ are described below in the context of using the sample holder with an optical device.

The wall capable of transmitting light may be formed of various materials, including glass, fused silica, or plastic (such as cycloolefin), among others. The material should transmit at least some light having a wavelength typically employed in optical assays, such as ultraviolet, visible, and/or infrared. To facilitate polarization assays, the material may be selected to substantially maintain the polarization of incident light as it passes from the outer surface to the inner surface, and/or of luminescence light as it passes from the inner surface back to the outer surface, if such luminescence is detected through the wall.

The index of refraction of the wall capable of transmitting light will depend on the material from which it is formed. Indices of refraction for familiar materials include 1.00 for air, 1.33 for water, 1.46 for fused silica, and 2.42 for diamond. Generally, to obtain total internal reflection, the index of refraction of the wall should exceed the maximum index of refraction of the preferred samples. Thus, the index of refraction of the wall should exceed about 1.3 if the preferred samples include water.

Optical device 42 includes an examination site 49, a light source 50 positioned to deliver light to the examination site, and a detector 51 positioned to receive light transmitted from the examination site. Optical device 42 also may include an excitation filter 52 for altering the intensity, spectrum, polarization, and/or other optical properties of the excitation light, an emission filter 53 for altering the intensity, spectrum, polarization, and/or other optical properties of the emission light, and/or other optical components. Light sources, detectors, excitation and emission filters, and other components of optical device 42 are described below in further detail.

Sample holder 41 and optical device 42 may be configured so that when the sample holder is positioned in the examination site, (1) the optical device is capable of exciting and detecting luminescence substantially exclusively from a sensed volume adjacent an inner surface of at least one sample well in the sample holder, or (2) the optical device is capable of exciting and detecting luminescence from the sample substantially without carrying light energy into a sample well.

In system 40, sample holder 41 and optical device 42 are configured to use total internal reflection for evanescent excitation of luminophores at or near a surface in a sample well in the sample holder.

Light source 50 is positioned so that it may direct incident excitation light (i) though outer surface 48 so that it impinges on inner surface 46 at an angle θ₁ sufficient for total internal reflection, creating an evanescent field 54 in sample well 44. In FIG. 4, light source 50 is positioned so that angle θᵢ is at least as large as the critical angle θ_{c}, where angle θᵢ is defined as the angle between incident excitation light (i) and normal \vec{N}ᵢₛ to inner surface 46. Moreover, light source 50 is positioned so that incident excitation light (i) is transmitted along normal \vec{N}ₒₛ to the outer surface, so that it passes through the outer surface substantially without changing direction. Light source 50 also may be positioned to direct light from other directions, including off-normal to avoid back reflections from outer surface 48.

Detector 51 is positioned so that it may detect luminescence (l) emitted by sample 47 within sample well 44 in response to excitation by evanescent field 54. Luminescence may be emitted isotropically or in particular directions, depending on the orientation of the luminophores and other factors. In FIG. 4, detector 51 is positioned so that it detects luminescence emitted along normal \vec{N}ᵢₛ to inner surface 46. However, detector 51 also may be positioned to detect luminescence emitted in other directions, including (1) anti-parallel to normal \vec{N}ᵢₛ, (2) so that the angle between incident excitation light (i) and detected luminescence light (l) is substantially different than 0, 90, or 180 degrees, or (3) so that the detector is not in the path of incident excitation light (i) or a principal reflection (r) of the excitation light.

In some applications, two sources of light may be used to create two evanescent fields. The two light sources may be separate light sources configured to produce light having the same and/or different wavelengths, or a single light source combined with a beamsplitter configured to separate light from the single source. Two sources may be used to create two evanescent fields with different properties, for example wavelength and/or penetration depth, where differences in luminescence detected using the two fields may be correlated with a property of the sample. Two sources also may be used to create two evanescent fields with similar properties, for example to create bleach and probe beams for a photobleaching assay.

In many applications, light will be directed at any given time from the light source to a single sample well, potentially maximizing the evanescent field formed in that sample well. In these applications, if a plurality of sample wells are to be analyzed, then that plurality preferentially is illuminated and detected from in series rather than in parallel, so that the intensity of light reaching each well more nearly is uniform.

A well-to-well analysis facilitates flexibility. For example, the wavelength and/or incidence angle of the incident light may be varied from well to well (or from assay to assay in the same well), permitting study of different luminophores and/or luminophores at different distances from the surface.

In other applications, light may be directed simultaneously to two or more wells. In these applications, light may be directed into a wave guide such that multiple total internal reflections are used to create simultaneous evanescent fields adjacent the inner surfaces of two or more sample wells.

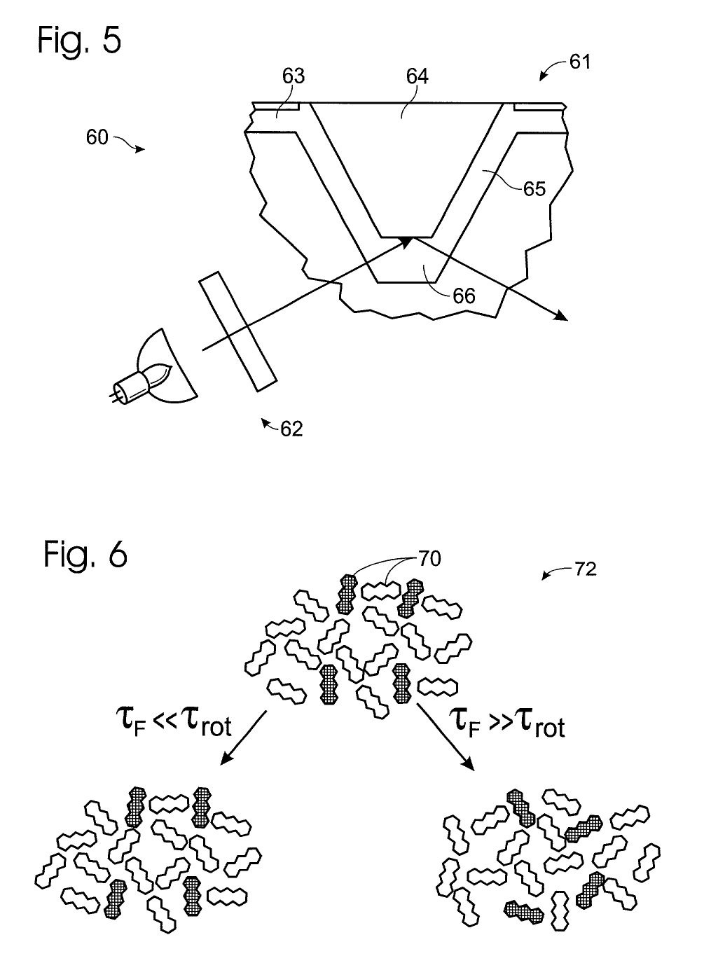

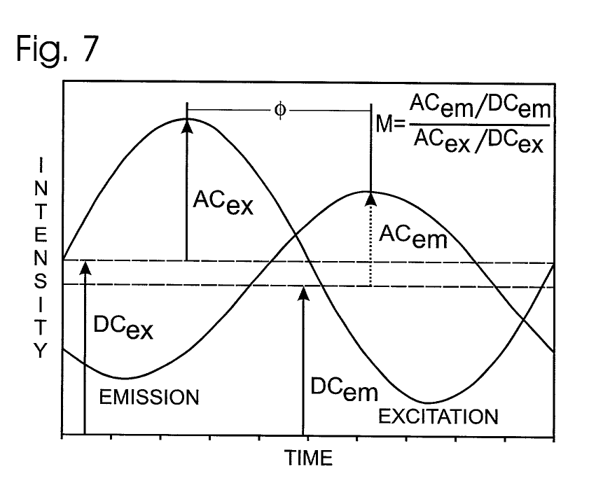

FIG. 5 shows a partially schematic cross-sectional view of portions of an alternative system 60 for detecting luminescence in accordance with the invention. System 60 includes a sample holder 61 and an optical device 62.

Sample holder 61 includes a frame 63 and a plurality of sample wells 64 disposed in the frame. Frame 63 resembles frames 31 and 43 described above. Sample wells 64 functionally resemble sample wells 32 and 46 described above, but structurally differ in their details. In particular, sample wells 64 are frusto-conical, with an angled side wall 65 and a substantially flat bottom wall 66 joined to the side wall. Bottom wall 66 is capable of transmitting light. A wall capable of transmitting light includes portions of side wall 65 and bottom wall 66.

In yet other embodiments, the invention includes a microplate constructed using optical materials selected and configured to cause luminescently tagged ligands at a desired surface of a microplate well to be excited by light energy in the form of an evanescent field. The evanescent field may result from light propagating through a wave-guide structure contained within the microplate. By proper design of the microplate shape and excitation optics, the excitation light can be directed away from the emission detection path, thereby reducing background caused by unintended detection of excitation light. In addition, because the evanescent field decays within a short distance from the surface (˜0.5 micrometers), only tagged ligands located within this region will luminesce. This effect will greatly reduce or effectively eliminate background signal from the bulk solution. This enables homogeneous assays to discriminate between signals generated close to the surface and those distributed throughout the solution.

3. Description of Luminescence Assays

TIR may be used in a variety of luminescence assays, including intensity, polarization, and luminescence lifetime. Such assays may be used to characterize cell-substrate contact regions, surface binding equilibria, surface orientation distributions, surface diffusion coefficients, and surface binding kinetic rates, among others. Such assays also may be used to look at proteins, including enzymes such as proteases, kinases, and phosphatases, as well as nucleic acids, including nucleic acids having polymorphisms such as single nucleotide polymorphisms (SNPs).

There are many examples of specific assays. Examples include ligand binding assays based on targets (molecules or living cells) situated at a surface. Other examples include functional assays on living cells at a surface, such as reporter-gene assays and assays for signal-transduction species such as intracellular calcium ion. Still other examples include enzyme assays, particularly where the enzyme acts on a surface-bound or immobilized species.

This evanescent field selectively excites luminescence from molecules in the medium of lower refractive index that are within the field penetration depth, i.e., close to the surface; this reduces detection of background luminescence by reducing excitation of background (e.g., bulk) luminophores. The exclusion of signal from the bulk phase (and the unusual polarization properties of the evanescent field) make TIR luminescence spectroscopy especially useful in studies of surface phenomena. Indeed, evanescent field excitation and time-resolved luminescence detection may be combined and used to create homogeneous and virtually background-free assays that require less than about one microliter of sample.

The remainder of this section is divided into four subsections relating to use of luminescence assays with total internal reflection: (A) intensity assays, (B) polarization assays, (C) time-resolved assays, and (D) strengths and weaknesses of luminescence assays. Additional luminescence assays, including fluorescence resonance energy transfer (FRET), fluorescence correlation spectroscopy (FCS), and fluorescence recovery after photobleaching (FRAP), as well as their phosphorescence analogs, also may be used with total internal reflection using procedures outlined in the patent applications and books cross-referenced above and/or generally known to persons of ordinary skill in the art.

A. Intensity Assays

Luminescence intensity assays involve monitoring the intensity (or amount) of light emitted from a composition. The intensity of emitted light will depend on the extinction coefficient, quantum yield, and number of the luminescent analytes in the composition, among others. These quantities, in turn, will depend on the environment on the analyte, among others, including the proximity and efficacy of quenchers and energy transfer partners. Thus, luminescence intensity assays may be used to study binding reactions, among other applications. In particular, intensity may be increased if binding localizes luminophores within a sensed volume or if binding enhances luminescence of luminophores already within the sensed volume. Conversely, intensity may be decreased if binding excludes luminophores from a sensed volume or if binding diminishes luminescence of luminophores already within the sensed volume.

B. Polarization Assays

Luminescence polarization assays involve the absorption and emission of polarized light, and typically are used to study molecular rotation. Polarization describes the direction of light's electric field. Generally, the polarization is perpendicular to the direction of light's propagation; however, in TIR, the polarization may include a component in the direction of propagation.

FIG. 6 is a schematic view showing how luminescence polarization is affected by molecular rotation. In a luminescence polarization assay, specific molecules 70 within a composition 72 are labeled with one or more luminophores. The composition then is illuminated with polarized excitation light, which preferentially excites luminophores having absorption dipoles aligned parallel to the polarization of the excitation light. These molecules subsequently decay by preferentially emitting light polarized parallel to their emission dipoles. The extent to which the total emitted light is polarized depends on the extent of molecular reorientation during the time interval between luminescence excitation and emission, which is termed the luminescence lifetime, τ. The extent of molecular reorientation in turn depends on the luminescence lifetime and the size, shape, and environment of the reorienting molecule. Thus, luminescence polarization assays may be used to quantify binding reactions and enzymatic activity, among other applications. In particular, molecules rotate via diffusion with a rotational correlation time τᵣₒₜ that is proportional to their size. Thus, during their luminescence lifetime, relatively large molecules will not reorient significantly, so that their total luminescence will be relatively polarized. In contrast, during the same time interval, relatively small molecules will reorient significantly, so that their total luminescence will be relatively unpolarized.

Polarization surface assays may use competitive or sandwich formats, among others, involving specific and/or nonspecific binding partners. Polarization assays are especially useful in the TIR context, because surface binding may be used to significantly reduce molecular mobility and so significantly increase polarization. To facilitate surface binding, one of the binding partners may be an inner surface of a sample holder or bound to an inner surface of a sample holder.

The relationship between polarization and intensity is expressed by the following equation:

$$P = \frac{{I}_{\vert \vert} - {I}_{⊥}}{{I}_{\vert \vert} + {I}_{⊥}} \qquad ( 6 )$$

Here, P is the polarization, I_{∥} is the intensity of luminescence polarized parallel to the polarization of the excitation light, and I_{⊥} is the intensity of luminescence polarized perpendicular to the polarization of the excitation light. If there is little rotation between excitation and emission, I_{∥} will be relatively large, I_{⊥} will be relatively small, and P will be close to one. (P may be less than one even if there is no rotation; for example, P will be less than one if the absorption and emission dipoles are not parallel.) In contrast, if there is significant rotation between absorption and emission, I_{∥} will be comparable to I_{⊥}, and P will be close to zero. Polarization often is reported in milli-P units (1000×P), which will range between 0 and 1000, because P will range between zero and one.

Polarization also may be described using other equivalent quantities, such as anisotropy. The relationship between anisotropy and intensity is expressed by the following equation:

$$r = \frac{{I}_{\vert \vert} - {I}_{⊥}}{{I}_{\vert \vert} + 2 {I}_{⊥}} \qquad ( 7 )$$

Here, r is the anisotropy. Polarization and anisotropy include the same information, although anisotropy may be more simply expressed for systems containing more than one luminophore. In the description and claims that follow, these terms may be used interchangeably, and a generic reference to one should be understood to imply a generic reference to the other.

The relationship between polarization and rotation is expressed by the Perrin equation:

$$( \frac{1}{P} - \frac{1}{3} ) = ( \frac{1}{{P}_{0}} - \frac{1}{3} ) \cdot ( 1 + \frac{τ}{{τ}_{rot}} ) \qquad ( 8 )$$

Here, P₀ is the polarization in the absence of molecular motion (intrinsic polarization), τ is the luminescence lifetime (inverse decay rate) as described above, and τᵣₒₜ is the rotational correlation time (inverse rotational rate) as described above.

The Perrin equation shows that luminescence polarization assays are most sensitive when the luminescence lifetime and the rotational correlation time are similar. Rotational correlation time is proportional to molecular weight, increasing by about 1 nanosecond for each 2,400 Dalton increase in molecular weight (for a spherical molecule). For shorter lifetime luminophores, such as fluorescein, which has a luminescence lifetime of roughly 4 nanoseconds, luminescence polarization assays are most sensitive for molecular weights less than about 40,000 Daltons. For longer lifetime probes, such as Ru(bpy)₂dcbpy (ruthenium 2,2′-dibipyridyl 4,4′-dicarboxyl-2,2′-bipyridine), which has a lifetime of roughly 400 nanoseconds, luminescence polarization assays are most sensitive for molecular weights between about 70,000 Daltons and 4,000,000 Daltons.

C. Time-Resolved Assays

Time-resolved assays involve measuring the time course of luminescence emission. Time-resolved assays may be conducted in the time domain or in the frequency domain, both of which are functionally equivalent. In a time-domain measurement, the time course of luminescence is monitored directly. Typically, a composition containing a luminescent analyte is illuminated using a narrow pulse of light, and the time dependence of the intensity of the resulting luminescence emission is observed, although other protocols also may be used. For a simple molecule, the luminescence commonly follows a single-exponential decay.

In a frequency-domain measurement, the time course of luminescence is monitored indirectly, in frequency space. Typically, the composition is illuminated using light whose intensity is modulated sinusoidally at a single modulation frequency ƒ, although other protocols (such as transforming time-domain data into the frequency domain) also may be used. The intensity of the resulting luminescence emission is modulated at the same frequency as the excitation light. However, the emission will lag the excitation by a phase angle (phase) φ, and the intensity of the emission will be demodulated relative to the intensity of the excitation by a demodulation factor (modulation) M.

FIG. 2 shows the relationship between emission and excitation in a single-frequency frequency-domain experiment. The phase φ is the phase difference between the excitation and emission. The modulation M is the ratio of the AC amplitude to the DC amplitude for the emission, relative to the ratio of the AC amplitude to the DC amplitude for the excitation. The phase and modulation are related to the luminescence lifetime τ by Equations 9 and 10.

ωτ=tan(φ) (9)

$$ω τ = \sqrt{\frac{1}{{M}^{2}} - 1} \qquad ( 10 )$$

Here ω is the angular modulation frequency, which equals 2π times the modulation frequency. For maximum sensitivity, the angular modulation frequency should be roughly the inverse of the luminescence lifetime. Lifetimes of interest in high-throughput screening vary from less than 1 nanosecond to greater than 10 microseconds. Therefore, instruments for high-throughput screening should be able to cover modulation frequencies from 20 kHz to 200 MHz.

D. Strengths and Weaknesses of Luminescence Assays

Luminescence methods have several significant potential strengths. First, luminescence methods may be very sensitive, because modern detectors, such as photomultiplier tubes (PMTs) and charge-coupled devices (CCDs), can detect very low levels of light. Second, luminescence methods may be very selective, because the luminescence signal may come almost exclusively from the luminophore.

Luminescence assays also have several significant potential weaknesses. First, luminescence from the analyte might be perturbed in some way, distorting results. For example, if a luminescent analyte binds to the walls of a sample holder during a luminescence polarization assay, the analyte will be unable to rotate, spuriously increasing the polarization. Second, luminescence may arise from sources other than the analyte, contaminating the signal. For example, luminescence may arise from the sample holder, including glass coverslips and plastic microplates.

4. Description of Luminescence Apparatus

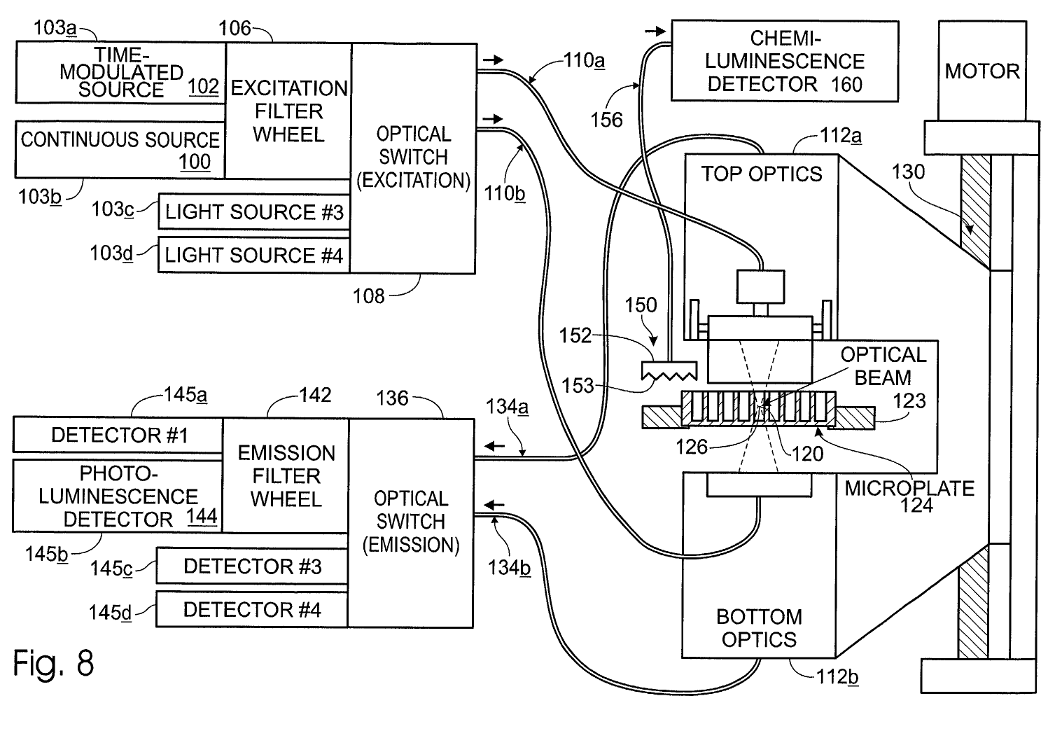

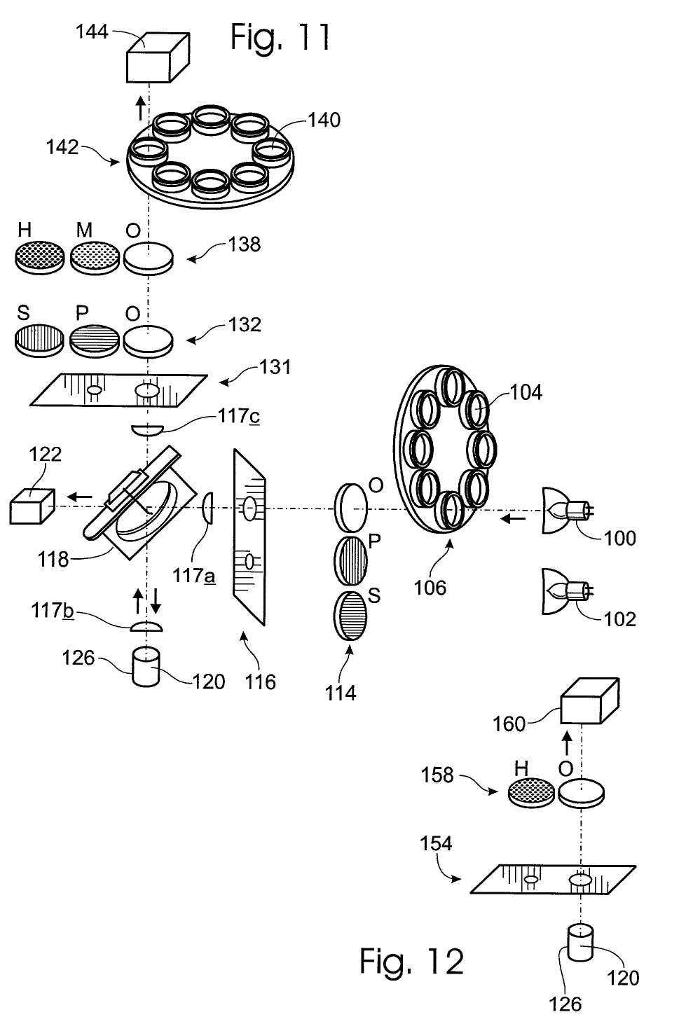

FIGS. 8-13 show an optical device or apparatus 90 for detecting light emitted by an analyte in a composition. Apparatus 90 includes (1) a stage for supporting the composition, (2) one or more light sources for delivering light to a composition, (3) one or more detectors for receiving light transmitted from the composition and converting it to a signal, (4) first and second optical relay structures for relaying light between the light source, composition, and detector, and (5) a processor for analyzing the signal from the detector. All or only a subset of these components may be used in any given application.

Apparatus 90 may be used for a variety of assays, including but not limited to the assays described above. Components of the optical system may be chosen to optimize sensitivity and dynamic range for each assay supported by the apparatus. Toward this end, optical components with low intrinsic luminescence are preferred. In addition, some components may be shared by different modes, whereas other components may be unique to a particular mode. For example, in apparatus 90, photoluminescence intensity and steady-state photoluminescence polarization modes share a light source; time-resolved luminescence modes use their own light source; and chemiluminescence modes do not use a light source. Similarly, photoluminescence and chemiluminescence modes use different detectors.

The remainder of this section is divided into six subsections: (A) photoluminescence optical system, (B) chemiluminescence optical system, (C) total internal reflection optical system, (D) housing, (E) alternative apparatus, and (F) methods of use.

5 A. Photoluminescence Optical System

FIGS. 8-11 show the photoluminescence optical system of apparatus 90. As configured here, apparatus 90 includes a continuous light source 100 and a time-modulated light source 102. Apparatus 90 includes light source slots 103a-d for four light sources, although other numbers of light source slots and light sources also could be provided. Light source slots 103a-d function as housings that may surround at least a portion of each light source, providing some protection from radiation and explosion. The direction of light transmission through the photoluminescence optical system is indicated by arrows.

Continuous source 100 provides light for photoluminescence intensity and steady-state photoluminescence polarization assays. Continuous light source 100 may include arc lamps, lasers, laser diodes, and light-emitting diodes (LEDs), among others. A preferred continuous source is a high-intensity, high color temperature xenon arc lamp, such as a Model LX175F CERMAX xenon lamp from ILC Technology, Inc. Color temperature is the absolute temperature in Kelvin at which a blackbody radiator must be operated to have a chromaticity equal to that of the light source. A high color temperature lamp produces more light than a low color temperature lamp, and it may have a maximum output shifted toward or into visible wavelengths and ultraviolet wavelengths where many luminophores absorb. The preferred continuous source has a color temperature of 5600 Kelvin, greatly exceeding the color temperature of about 3000 Kelvin for a tungsten filament source. The preferred source provides more light per unit time than flash sources, increasing sensitivity and reducing read times. Apparatus 90 may include a modulator mechanism configured to vary the intensity of light incident on the composition without varying the intensity of light produced by the light source.

Time-modulated source 102 provides light for time-resolved photoluminescence assays, such as photoluminescence lifetime and time-resolved photoluminescence polarization assays. A preferred time-modulated source is a xenon flash lamp, such as a Model FX-1160 xenon flash lamp from EG&G Electro-Optics. The preferred source produces a “flash” of light for a brief interval before signal detection and is especially well suited for time-domain measurements. Other time-modulated sources include pulsed lasers, electronically modulated lasers and LEDs, and continuous lamps and other sources whose intensity can be modulated extrinsically using a Pockels cell, Kerr cell, or other mechanism. Such other mechanisms may include an amplitude modulator such as a chopper as described in U.S. Provisional Patent Application No. 60/094,276, which is incorporated herein by reference. Extrinsically modulated continuous light sources are especially well suited for frequency-domain measurements.

In apparatus 90, continuous source 100 and time-modulated source 102 produce multichromatic, unpolarized, and incoherent light that may be at least partially collimated before use. Continuous source 100 produces substantially continuous illumination, whereas time-modulated source 102 produces time-modulated illumination. Light from these light sources may be delivered to the sample without modification, or it may be filtered to alter its intensity, spectrum, polarization, or other properties.

Light produced by the light sources follows an excitation optical path to an examination site. Such light may pass through one or more “spectral filters,” which generally comprise any mechanism for altering the spectrum of light that is delivered to the sample. Spectrum refers to the wavelength composition of light. A spectral filter may be used to convert white or multichromatic light, which includes light of many colors, into red, blue, green, or other substantially monochromatic light, which includes light of one or only a few colors. In apparatus 90, spectrum is altered by an excitation interference filter 104, which selectively transmits light of preselected wavelengths and selectively absorbs light of other wavelengths. For convenience, excitation interference filters 104 may be housed in an excitation filter wheel 106, which allows the spectrum of excitation light to be changed by rotating a preselected filter into the optical path. Spectral filters also may separate light spatially by wavelength. Examples include gratings, monochromators, and prisms.

Spectral filters are not required for monochromatic (“single color”) light sources, such as certain lasers, which output light of only a single wavelength. Therefore, excitation filter wheel 106 may be mounted in the optical path of some light source slots 103a,b, but not other light source slots 103c,d.

Light next passes through an excitation optical shuttle (or switch) 108, which positions an excitation fiber optic cable 110a,b in front of the appropriate light source to deliver light to top or bottom optics heads 112a,b, respectively. Light is transmitted through a fiber optic cable much like water is transmitted through a garden hose. Fiber optic cables can be used easily to turn light around corners and to route light around opaque components of the apparatus. Moreover, fiber optic cables give the light a more uniform intensity profile. A preferred fiber optic cable is a fused silicon bundle, which has low autoluminescence. Despite these advantages, light also can be delivered to the optics heads using other mechanisms, such as mirrors.

Light arriving at the optics head may pass through one or more excitation “polarization filters,” which generally comprise any mechanism for altering the polarization of light. Excitation polarization filters may be included with the top and/or bottom optics head. In apparatus 90, polarization is altered by excitation polarizers 114, which are included only with top optics head 112a; however, such polarizers also can be included with bottom optics head 112b for bottom reading. Excitation polarization filters 114 may include an s-polarizer S that passes only s-polarized light, a p-polarizer P that passes only p-polarized light, and a blank O that passes substantially all light. Excitation polarizers 114 also may include a standard or ferro-electric liquid crystal display (LCD) polarization switching system. Such a system is faster and more economical than a mechanical switcher. Excitation polarizers 114 also may include a continuous mode LCD polarization rotator with synchronous detection to increase the signal-to-noise ratio in polarization assays. Excitation polarizers 114 may be included in light sources, such as certain lasers, that intrinsically produce polarized light.

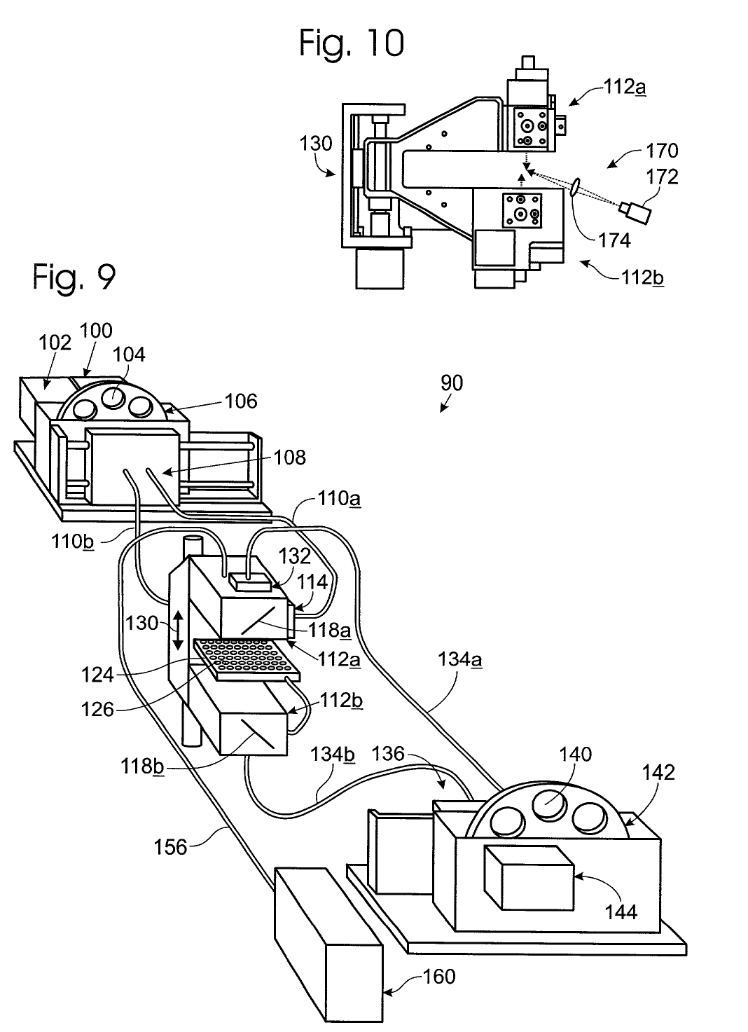

Light at one or both optics heads also may pass through an excitation “confocal optics element,” which generally comprises any mechanism for focusing light into a “sensed volume.” In apparatus 90, the confocal optics element includes a set of lenses 117a-c and an excitation aperture 116 placed in an image plane conjugate to the sensed volume, as shown in FIG. 9. Aperture 116 may be implemented directly, as an aperture, or indirectly, as the end of a fiber optic cable. Preferred apertures have diameters of 1 mm and 1.5 mm. Lenses 117a,b project an image of aperture 116 onto the sample, so that only a preselected or sensed volume of the sample is illuminated. The area of illumination will have a diameter corresponding to the diameter of the excitation aperture.

Light traveling through the optics heads is reflected and transmitted through a beamsplitter 118, which delivers reflected light to a composition 120 and transmitted light to a light monitor 122. Reflected and transmitted light both pass through lens 117b, which is operatively positioned between beamsplitter 1 18 and composition 120.

Beamsplitter 118 is used to direct excitation light toward the sample and light monitor, and to direct emission light toward the detector. The beamsplitter is changeable, so that it may be optimized for different assay modes or compositions. If a large number or variety of luminescent molecules are to be studied, the beamsplitter must be able to accommodate light of many wavelengths; in this case, a “50:50” beamsplitter that reflects half and transmits half of the incident light independent of wavelength is optimal. Such a beamsplitter can be used with many types of molecules, while still delivering considerable excitation light onto the composition, and while still transmitting considerable emission light to the detector. If one or a few related luminescent molecules are to be studied, the beamsplitter needs only to be able to accommodate light at a limited number of wavelengths; in this case, a “dichroic” or “multichroic” beamsplitter is optimal. Such a beamsplitter can be designed with cutoff wavelengths for the appropriate set of molecules and will reflect most or substantially all of the excitation and background light, while transmitting most or substantially all of the emission light. This is possible because the reflectivity and transmissivity of the beamsplitter can be varied with wavelength.

Light monitor 122 is used to correct for fluctuations in the intensity of light provided by the light sources; such corrections may be performed by reporting detected intensities as a ratio over corresponding times of the luminescence intensity measured by the detector to the excitation light intensity measured by the light monitor. The light monitor also can be programmed to alert the user if the light source fails. A preferred light monitor is a silicon photodiode with a quartz window for low autoluminescence.

The composition (or sample) may be held in a sample holder supported by a stage 123. The composition can include compounds, mixtures, surfaces, solutions, emulsions, suspensions, cell cultures, fermentation cultures, cells, tissues, secretions, and/or derivatives and/or extracts thereof. Analysis of the composition may involve measuring the presence, concentration, or physical properties (including interactions) of a photoluminescent analyte in such a composition. The sample holder can include microplates, biochips, or any array of samples in a known format. In apparatus 90, the preferred sample holder is a microplate 124, which includes a plurality of microplate wells 126 for holding compositions. Composition may refer to the contents of a single microplate well, or several microplate wells, depending on the assay. In some embodiments, such as a portable apparatus, the stage may be intrinsic to the instrument. The stage may be used automatically to bring successive samples into the examination area for analysis.

The sensed volume typically has an hourglass shape, with a cone angle of about 25° and a minimum diameter ranging between 0.1 mm and 2.0 mm. For 96-well and 384-well microplates, a preferred minimum diameter is about 1.5 mm. For 1536-well microplates, a preferred minimum diameter is about 1.0 mm. The size and shape of the sample holder may be matched to the size and shape of the sensed volume.

The position of the sensed volume can be moved precisely within the composition to optimize the signal-to-noise and signal-to-background ratios. For example, the sensed volume may be moved away from walls in the sample holder to optimize signal-to-noise and signal-to-background ratios, reducing spurious signals that might arise from luminophores bound to the walls and thereby immobilized. In apparatus 90, position in the X,Y-plane perpendicular to the optical path is controlled by moving the stage supporting the composition, whereas position along the Z-axis parallel to the optical path is controlled by moving the optics heads using a Z-axis adjustment mechanism 130, as shown in FIGS. 8-10. However, any mechanism for bringing the sensed volume into register or alignment with the appropriate portion of the composition also may be employed.

The combination of top and bottom optics permits assays to combine: (1) top illumination and top detection, or (2) top illumination and bottom detection, or (3) bottom illumination and top detection, or (4) bottom illumination and bottom detection. Same-side illumination and detection (1) and (4) is referred to as “epi” and is preferred for photoluminescence assays. Opposite-side illumination and detection (2) and (3) is referred to as “trans” and may be used for absorbance assays. In apparatus 90, epi modes are supported, so the excitation and emission light travel the same path in the optics head, albeit in opposite or anti-parallel directions; however, trans modes also could be supported. Generally, top optics can be used with any sample holder having an open top, whereas bottom optics can be used only with sample holders having optically transparent bottoms, such as glass or thin plastic bottoms.

Light typically is transmitted by the composition in multiple directions. A portion of the transmitted light will follow an emission pathway to a detector. Transmitted light passes through lens 117c and may pass through an emission aperture 131 and/or an emission polarizer 132. In apparatus 90, the emission aperture is placed in an image plane conjugate to the sensed volume and transmits light substantially exclusively from this sensed volume. In apparatus 90, the emission apertures in the top and bottom optical systems are the same size as the associated excitation apertures, although other sizes also may be used. The emission polarizers are included only with top optics head 112a. The emission aperture and emission polarizer are substantially similar to their excitation counterparts. Emission polarizer 132 may be included in detectors that intrinsically detect the polarization of light.

Excitation polarizers 114 and emission polarizers 132 may be used together in nonpolarization assays to reject certain background signals. Luminescence from the sample holder and from luminescent molecules adhered to the sample holder is expected to be polarized, because the rotational mobility of these molecules should be hindered. Such polarized background signals can be eliminated by “crossing” the excitation and emission polarizers, that is, setting the angle between their transmission axes at 90°. As described above, such polarized background signals also can be reduced by moving the sensed volume away from walls of the sample holder. To increase signal level, beamsplifter 118 should be optimized for reflection of one polarization and transmission of the other polarization. This method will work best where the luminescent molecules of interest emit relatively unpolarized light, as will be true for small luminescent molecules in solution.

Transmitted light next passes through an emission fiber optic cable 134a,b to an emission optical shuttle (or switch) 136. This shuttle positions the appropriate emission fiber optic cable in front of the appropriate detector. In apparatus 90, these components are substantially similar to their excitation counterparts, although other mechanisms also could be employed.

Light exiting the fiber optic cable next may pass through one or more emission “intensity filters,” which generally comprise any mechanism for reducing the intensity of light. Intensity refers to the amount of light per unit area per unit time. In apparatus 90, intensity is altered by emission neutral density filters 138, which absorb light substantially independent of its wavelength, dissipating the absorbed energy as heat. Emission neutral density filters 138 may include a high-density filter H that absorbs most incident light, a medium-density filter M that absorbs somewhat less incident light, and a blank O that absorbs substantially no incident light. These filters may be changed manually or automatically, for example, by using a filter wheel. Intensity filters also may divert a portion of the light away from the sample without absorption. Examples include beam splitters, which transmit some light along one path and reflect other light along another path, and Pockels cells, which deflect light along different paths through diffraction. Examples also include hot mirrors or windows that transmit light of some wavelengths and absorb light of other wavelengths.

Light next may pass through an emission interference filter 140, which may be housed in an emission filter wheel 142. In apparatus 90, these components are substantially similar to their excitation counterparts, although other mechanisms also could be employed. Emission interference filters block stray excitation light, which may enter the emission path through various mechanisms, including reflection and scattering. If unblocked, such stray excitation light could be detected and misidentified as photoluminescence, decreasing the signal-to-background ratio. Emission interference filters can separate photoluminescence from excitation light because photoluminescence has longer wavelengths than the associated excitation light. Luminescence typically has wavelengths between 200 and 2000 nanometers.

The relative positions of the spectral, intensity, polarization, and other filters presented in this description may be varied without departing from the spirit of the invention. For example, filters used here in only one optical path, such as intensity filters, also may be used in other optical paths. In addition, filters used here in only top or bottom optics, such as polarization filters, may also be used in the other of top or bottom optics or in both top and bottom optics. The optimal positions and combinations of filters for a particular experiment will depend on the assay mode and the composition, among other factors.

Light last passes to a detector, which is used in absorbance and photoluminescence assays. In apparatus 90, there is one photoluminescence detector 144, which detects light from all photoluminescence modes. A preferred detector is a photomultiplier tube (PMT). Apparatus 90 includes detector slots 145a-d for four detectors, although other numbers of detector slots and detectors also could be provided.

More generally, detectors comprise any mechanism capable of converting energy from detected light into signals that may be processed by the apparatus, and by the processor in particular. Suitable detectors include photomultiplier tubes, photodiodes, avalanche photodiodes, charge-coupled devices (CCDs), and intensified CCDs, among others. Depending on the detector, light source, and assay mode, such detectors may be used in a variety of detection modes. These detection modes include (1) discrete (e.g., photon-counting) modes, (2) analog (e.g., current-integration) modes, and/or (3) imaging modes, among others, as described below.

B. Chemiluminescence Optical System

FIGS. 8, 9, and 12 show the chemiluminescence optical system of apparatus 90. Because chemiluminescence follows a chemical event rather than the absorption of light, the chemiluminescence optical system does not require a light source or other excitation optical components. Instead, the chemiluminescence optical system requires only selected emission optical components. In apparatus 90, a separate lensless chemiluminescence optical system is employed, which is optimized for maximum sensitivity in the detection of chemiluminescence.

Generally, components of the chemiluminescence optical system perform the same functions and are subject to the same caveats and alternatives as their counterparts in the photoluminescence optical system. The chemiluminescence optical system also can be used for other assay modes that do not require illumination, such as electrochemiluminescence.

The chemiluminescence optical path begins with a chemiluminescent composition 120 held in a sample holder 126. The composition and sample holder are analogous to those used in photoluminescence assays; however, analysis of the composition involves measuring the intensity of light generated by a chemiluminescence reaction within the composition rather than by light-induced photoluminescence. A familiar example of chemiluminescence is the glow of the firefly.

Chemiluminescence light typically is transmitted from the composition in all directions, although most will be absorbed or reflected by the walls of the sample holder. A portion of the light transmitted through the top of the well is collected using a chemiluminescence head 150, as shown in FIG. 8, and will follow a chemiluminescence optical pathway to a detector. The direction of light transmission through the chemiluminescence optical system is indicated by arrows.

The chemiluminescence head includes a nonconfocal mechanism for transmitting light from a sensed volume within the composition. Detecting from a sensed volume reduces contributions to the chemiluminescence signal resulting from “cross talk,” which is pickup from neighboring wells. The nonconfocal mechanism includes a chemiluminescence baffle 152, which includes rugosities 153 that absorb or reflect light from other wells. The nonconfocal mechanism also includes a chemiluminescence aperture 154 that further confines detection to a sensed volume.

Light next passes through a chemiluminescence fiber optic cable 156, which may be replaced by any suitable mechanism for directing light from the composition toward the detector. Fiber optic cable 156 is analogous to excitation and emission fiber optic cables 110a,b and 134a,b in the photoluminescence optical system. Fiber optic cable 156 may include a transparent, open-ended lumen that may be filled with fluid. This lumen would allow the fiber optic to be used both to transmit luminescence from a microplate well and to dispense fluids into the microplate well. The effect of such a lumen on the optical properties of the fiber optic could be minimized by employing transparent fluids having optical indices matched to the optical index of the fiber optic.

Light next passes through one or more chemiluminescence intensity filters, which generally comprise any mechanism for reducing the intensity of light. In apparatus 50, intensity is altered by chemiluminescence neutral density filters 158. Light also may pass through other filters, if desired.

Light last passes to a detector, which converts light into signals that may be processed by the apparatus. In apparatus 50, there is one chemiluminescence detector 160. This detector may be selected to optimize detection of blue/green light, which is the type most often produced in chemiluminescence. A preferred detection is a photomultiplier tube, selected for high quantum efficiency and low dark count at chemiluminescence wavelengths (400-500 nanometers).

C. Total Internal Reflection Optical System

FIG. 10 shows the total internal reflection optical system of apparatus 90. The total internal reflection optical system includes an alternative optical relay structure 170 configured for off-axis illumination. The alternative optical relay structure may take may various forms. In FIG. 10, alternative optical relay structure 170 includes a fiber optic cable 172 and a focusing lens structure 174 for directing light onto a microplate wall capable of transmitting light.

Off-axis illumination also may be used during photoluminescence illumination to reduce loss of light due to absorption and reflection from the beam splitter and to reduce reflection of incident light into the detection optics, reducing background.

D. Housing

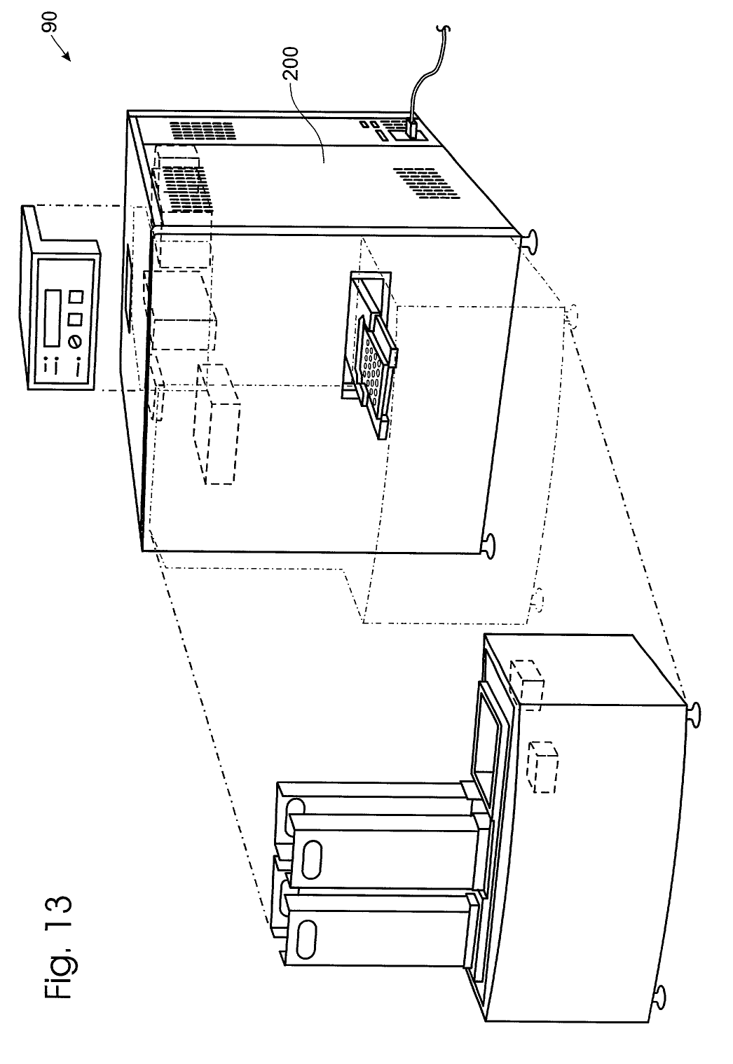

FIG. 13 shows a housing 200 and other accessories for the apparatus of FIGS. 8-12. Housing 200 substantially encloses the apparatus, forming (together with light source slots 103a-d) two protective layers around the continuous high color temperature xenon arc lamp. Housing 200 permits automated sample loading and switching among light sources and detectors, further protecting the operator from the xenon arc lamp and other components of the system.

E. Alternative Apparatus

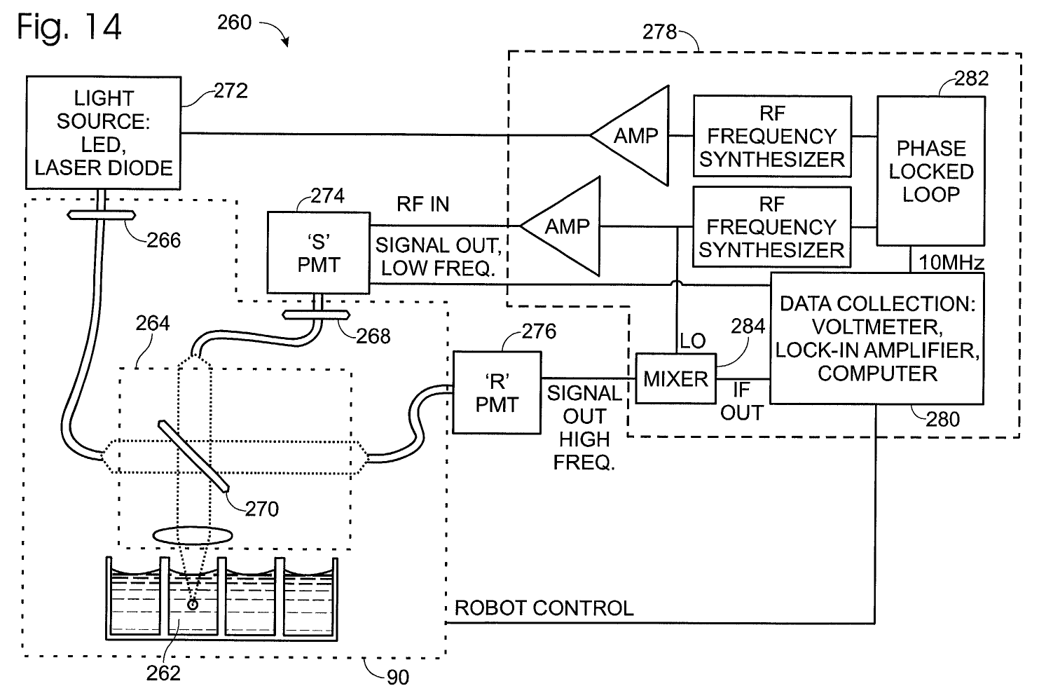

FIG. 14 shows an alternative apparatus 260 for detecting light emitted by an analyte in a composition 262. Apparatus 260 includes substantial portions of apparatus 90, including its fiber-optic-coupled optics head 264, excitation 266 and emission 268 filters, dichroic beam splitter 270, and mechanisms for sample positioning and focus control. However, apparatus 260 also may include alternative light sources 272, alternative sample (‘S’) 274 and reference (‘R’) 276 detectors, and alternative detection electronics 278. In FIG. 14, alternative components 272-278 are shown outside apparatus 90, but they readily may be included inside housing 200 of apparatus 90, if desired.

Apparatus 260 may excite luminescence in various ways, such as using an LED or laser diode light source. For example, analytes absorbing blue light may be excited using a NICHIA-brand bright-blue LED (Model Number NSPB500; Mountville, Pa.). This LED produces broad-spectrum excitation light, so excitation filter 266 typically is used to block the red edge of the spectrum. If analytes are excited using a laser diode, an excitation filter is not necessary.

Apparatus 260 may detect luminescence and convert it to a signal in various ways. Luminescence can be detected using sample PMT 274, which may be an ISS-brand gain-modulated PMT (Champaign, Ill.). High-frequency luminescence can be frequency down-converted to a low-frequency signal using a technique called heterodyning. The phase and modulation of the low-frequency signal can be determined using a lock-in amplifier 280, such as a STANFORD RESEARCH SYSTEMS brand lock-in amplifier (Model Number SR830; Sunnyvale, Calif.). Lock-in amplifier 280 is phase locked using a phase-locked loop 282 to the modulation frequency of light source 272. To correct for drift in the light source, the output of light source 272 may be monitored using reference PMT 276, which may be a HAMAMATSU-brand PMT (Model Number H6780; Bridgewater, N.J.). If reference PMT 276 can respond to high-frequency signals, the heterodyning step can be performed using an external mixer 284. The phase and modulation of reference PMT 276 also may be captured by lock-in amplifier 280 and used to normalize the signal from sample PMT 274.

A computer or processor controls the apparatus, including the external components. The computer also directs sample handling and data collection. Generally, phase and modulation data are collected at one or more frequencies appropriate for the lifetime of the analyte. In some cases, phase and modulation may be measured at one or a few frequencies and processed by the computer or processor to help reduce detected background.

The invention also may employ other apparatus or optical devices having yet other combinations of components. Such apparatus and devices may have a high color temperature light source, and/or be capable of detecting light substantially exclusively from a sensed volume.

F. Methods of Measuring Luminescence

Apparatus 90 and 260 may be used to conduct a variety of steady-state and time-resolved luminescence assays. Steady-state assays measure luminescence under constant illumination, using the continuous light source. Time-resolved polarization assays measure luminescence as a function of time, using either the continuous light source, with its intensity appropriately modulated, or the time-varying light source.

Intensity assays may be conducted by monitoring the intensity of the luminescence emitted by the composition.

Polarization assays may be conducted as follows. Excitation light from the continuous light source is directed through an excitation filter, low-luminescence fiber optic cable, and excitation polarization filter. Excitation light then is directed to a beamsplitter, which reflects most of the light onto a composition and transmits a little of the light into a light monitor. Emitted light from the composition is directed back through the beamsplitter and then is directed through another low-luminescence fiber optic cable, an emission filter, and a polarization filter (in either the S or P orientation) before detection by a photomultiplier tube or other detector. Two measurements are performed for each composition, one with excitation and emission polarizers aligned and one with excitation and emission polarizers crossed. Either polarizer may be static or dynamic, and either polarizer may be set in the S or P orientation, although typically the excitation polarizer is set in the S orientation. Polarization experiments using evanescent illumination should take into account the unusual polarization properties of the evanescent field, as described above in Equations 4 and 5.

Steady-state polarization assays also may be conducted by constantly polarizing and transmitting high color temperature light to an examination site as successive samples are automatically, serially aligned in an optical path intersecting the examination site, and detecting polarized light emitted from each sample.

Additional detection methods are presented in PCT Patent Application Serial Nos. PCT/US99/01656 and PCT/US99/03678, which are incorporated herein by reference, as well as other patent applications and books listed above under Cross-References. For example, experiments may be conducted using flash/wait/detect detection schemes, which may reduce detection of short-lifetime autoluminescence by waiting to detect light until after such autoluminescence has decayed (typically 10-20 nanoseconds). Experiments also may be conducted using a bright flash followed by steady-state dim-illumination detection to perform photobleaching recovery experiments. Photobleaching experiments may be performed using at least two different optical geometries. In one geometry, a laser beam with a circular Gaussian intensity profile is totally internally reflected, creating an evanescent intensity profile that varies approximately as an elliptical Gaussian in the plane at which the laser beam totally internally reflects. In another geometry, two totally internally reflected laser beams are intersected to create a periodic evanescent interference pattern.

Although the invention has been disclosed in its preferred forms, the specific embodiments thereof as disclosed and illustrated herein are not to be considered in a limiting sense, because numerous variations are possible. Applicant regards the subject matter of his invention to include all novel and nonobvious combinations and subcombinations of the various elements, features, functions, and/or properties disclosed herein. No single feature, function, element or property of the disclosed embodiments is essential. The following claims define certain combinations and subcombinations of features, functions, elements, and/or properties that are regarded as novel and nonobvious. Other combinations and subcombinations may be claimed through amendment of the present claims or presentation of new claims in this or a related application. Such claims, whether they are broader, narrower, equal, or different in scope to the original claims, also are regarded as included within the subject matter of applicant's invention.

We claim:

1. A microplate for holding a plurality of samples, the microplate comprising:
a frame; and
a plurality of sample wells disposed in the frame, at least one sample well having a wall capable of transmitting light, a portion of the wall having an inner surface and an opposing outer surface, wherein the inner and outer surfaces are not parallel.

2. The microplate of claim 1, each sample well having a wall capable of transmitting light, the wall having an inner surface configured to contact a sample held within the sample well and an outer surface capable of transmitting light incident on the outer surface to the inner surface, wherein at least a portion of the inner surface is substantially flat, and wherein at least a portion of the outer surface makes an angle greater than about 42° degrees with respect to the substantially flat portion of the inner surface.

3. The microplate of claim 1, the wall having an index of refraction, wherein the angle is chosen so that light incident on at least a portion of the outer surface along a normal to that portion of the outer surface will be totally internally reflected at the inner surface when the sample well is empty.

4. The microplate of claim 1, the wall having an index of refraction, wherein the angle is chosen so that light incident on the outer surface along a normal to the outer surface will be totally internally reflected at the inner surface when the sample well contains water.

5. The microplate of claim 1, the wall having an index of refraction, wherein the index of refraction is at least about 1.3.

6. The microplate of claim 1, the at least one sample well including a side wall and a bottom wall joined to the side wall, wherein the bottom wall is the wall capable of transmitting light.

7. The microplate of claim 6, the side wall having an inner surface, wherein the inner surface of the side wall and the inner surface of the bottom wall form a frustum of cone having a cone angle of at least about 8 degrees.

8. The microplate of claim 1, the outer surface forming a frustum of cone.

9. The microplate of claim 1, the outer surface forming at least a portion of a spheroid, ellipsoid, or paraboloid.

10. The microplate of claim 1, wherein the inner surface includes a coating capable of increasing the penetration of the evanescent field into the sample well.

11. The microplate of claim 1, the at least one sample well having an open end through which sample may be added or removed, wherein the wall capable of transmitting light is opposite the open end.

12. The microplate of claim 1, wherein the at least one sample well is radially symmetric.

13. The microplate of claim 1, wherein the frame is substantially rectangular.

14. The microplate of claim 1, wherein the wall capable of transmitting light includes at least one of the following compositions: plastic, glass, and fused silica.

15. The microplate of claim 1, wherein the wall is formed of a composition that substantially maintains the polarization of incident light.

16. The microplate of claim 1, wherein the frame is configured to function as a wave guide, so that multiple internal reflections may be used to create simultaneous evanescent fields adjacent the inner surfaces of at least two sample wells.

17. The microplate of claim 1, wherein the microplate includes at least about 384 sample wells.

18. The microplate of claim 1, wherein each sample well holds no more than about 55 microliters.

19. The microplate of claim 18, wherein each sample well holds no more than about 5 microliters.

20. The microplate of claim 1, wherein the thickness of the wall capable of transmitting light is not uniform.

21. A method for detecting luminescence emitted by a sample, the method comprising:
providing a microplate having a plurality of sample wells, at least one sample well having a wall capable of transmitting light, the wall having an inner surface configured to contact a sample held within the sample well and an opposing outer surface that is not parallel to the inner surface;
directing excitation light through the outer surface so that it impinges on the inner surface at an angle sufficient for total internal reflection, so that an evanescent field is created in the sample well; and
detecting luminescence emitted by a sample within the sample well in response to excitation by the evanescent field.

22. The method of claim 21, wherein each sample well has a wall capable of transmitting light, the wall having an inner surface configured to contact a sample held within the sample well and an opposing outer surface.

23. The method of claim 22 further comprising:
directing excitation light through the outer surface of a second sample well so that the excitation light impinges on the inner surface of the second sample well at an angle sufficient for total internal reflection, so that an evanescent field is created in the second sample well; and
detecting luminescence emitted by a sample within the second sample well in response to the evanescent field.

24. The method of claim 23 further comprising correlating a difference in luminescence detected from the first and second sample wells with a difference in a Property of the samples in the first and second sample wells.

25. The method of claim 21, the at least one sample well including a side wall and a bottom wall joined to the side wall, wherein the bottom wall is the wall capable of transmitting light.

26. The method of claim 25, wherein the side wall and bottom wall form a frustum of cone having a cone angle of at least about 8 degrees.

27. The method of claim 21, wherein the directing step includes orienting the direction of excitation light substantially normal to the outer surface.

28. The method of claim 21, wherein the wall capable of transmitting light includes at least one of the following compositions: plastic, glass, and fused silica.

29. The method of claim 21, wherein the inner surface includes a coating capable of increasing the penetration of the evanescent field into the sample well.

30. The method of claim 21, wherein the step of directing excitation light through the outer surface includes orienting the excitation light so that it is transmitted through the outer surface substantially without changing direction.

31. The method of claim 21, wherein the exciting light is substantially collimated.

32. The method of claim 21, wherein the step of detecting luminescence emitted by the sample includes positioning a detector so that the angle between the incident excitation light and detected emission light is substantially different than 0, 90, and 180 degrees.

33. The method of claim 21, wherein the step of detecting luminescence emitted by the sample includes positioning a detector so that it is not in the path of the excitation light or a principal reflection of the excitation light.

34. The method of claim 21, wherein the luminescence emitted by the sample is used in a luminescence intensity assay, a luminescence polarization assay, or a luminescence resonance energy transfer assay.

35. The method of claim 21 further comprising correlating the luminescence emitted by the sample with binding between a first and second binding partner, at least the second binding partner being associated with the sample.

36. The method of claim 35, wherein the first binding partner is the inner surface.

37. The method of claim 35, wherein the first binding partner is bound to the inner surface.

38. The method of claim 35, wherein the luminescence emitted by the sample is enhanced by the binding between the first and second binding partners.

39. The method of claim 35, wherein the luminescence emitted by the sample is diminished by binding between the first and second binding partners.

40. The method of claim 35, wherein at least one of the first and second binding partners is a protein or a nucleic acid.

41. The method of claim 21, the excitation light being directed through the outer surface at a first angle to form a first evanescent field characterized by a first penetration depth, further comprising:
directing the excitation light through the outer surface at a second angle to form a second evanescent field characterized by a second penetration depth; and
detecting luminescence emitted by the sample in response to excitation by the second evanescent field.

42. The method of claim 41, further comprising correlating the difference in luminescence detected from the first and second evanescent fields with a property of the sample.

43. The method of claim 21, wherein the step of directing excitation light through the outer surface includes orienting the excitation light so that it impinges on the outer surface substantially along a normal to outer surface.

44. The method of claim 21, wherein the step of directing excitation light through the outer surface includes orienting the excitation light so that it impinges on the outer surface substantially off a normal to reduce back reflections.

45. The method of claim 21, the sample including bulk solution and the solution near the inner surface, further comprising discriminating between

46. The method of claim 21, wherein the steps of directing and detecting include illuminating, waiting, and detecting, so that short lifetime luminescence substantially decays before detection.

47. A system for detecting luminescence emitted by a sample, the system comprising:
a sample holder having a frame and a plurality of sample wells disposed in the frame, each sample well configured to hold a fluid sample; and
an optical device having an examination site, a light source positioned to deliver light to the examination site, and a detector positioned to receive light transmitted from the examination site;
wherein the sample holder and optical device are configured so that when the sample holder is positioned in the examination site, the optical device is capable of exciting and detecting luminescence substantially exclusively from a sensed volume adjacent an inner surface of at least one sample well in the sample holder.

48. A system for detecting luminescence emitted by a sample, the system comprising:
a sample holder having a frame and a plurality of sample wells disposed in the frame, each sample well configured to hold a fluid sample; and
an optical device having an examination site, a light source positioned to deliver excitation light to the examination site, and a detector positioned to receive emission light transmitted from the examination site;
wherein the sample holder and optical device are configured so that when the sample holder is positioned in the examination site, the optical device is capable of exciting and detecting luminescence from the sample substantially without carrying light energy into a sample well.

49. A method for detecting luminescence emitted by a sample, the method comprising:
directing light substantially normal to an exterior surface of a microplate well sample container;
totally internally reflecting the light from an internal surface of the container; and
detecting luminescence emitted by a sample within the sample well in response to excitation by the evanescent field.

50. A microplate for holding a plurality of samples, the microplate comprising:
a frame; and
a plurality of sample wells disposed in the frame, at least one sample well having a wall capable of transmitting light, the wall having a nonuniform thickness that provides an optimal angle of incidence of incoming light through an outer surface of the well and total internal reflection at an opposing internal interface in the well.
